(19) United States
(12) Patent Application Publication
(10) Pub. No.: US 2026/0101227 A1
(43) Pub. Date: Apr. 9, 2026

(54) Message Pacing Management Systems and Methods

(71) Applicant: Itron, Inc., Liberty Lake, WA (US)

(72) Inventors: Imad Jamil, Meudon (FR); Thomas Uhling, Spokane Valley, WA (US); Sateesh Tulluri, Bengaluru (IN)

(21) Appl. No.: 19/000,179

(22) Filed: Dec. 23, 2024

Related U.S. Application Data
(60) Provisional application No. 63/703,752, filed on Oct. 4, 2024.

(51) Int. Cl. H04W 28/02; H04W 28/14

(52) U.S. Cl. CPC H04W 28/0221; H04W 28/14

(57) ABSTRACT

Techniques for pacing messages in networked devices are described herein. A device receives a message to be sent to another device in a network of devices, determines when to send the message to the other device based on: a first pacing requirement, limiting messages that can be sent to first hop neighbors of the device to a first number of messages per unit of time; and a second pacing requirement limiting messages that can be sent to devices beyond the first hop neighbors of the device to a second number of messages, smaller than the first number of messages, per unit of time. The device sending the message to the other device at a time based at least in part on the first pacing requirement and the second pacing requirement.

### CROSS REFERENCE TO RELATED APPLICATION

This application claims the benefit of U.S. Provisional Application No. 63/703,752, filed Oct. 4, 2024, which is incorporated by reference herein.

### BACKGROUND

Utility companies provide gas, water, electricity, sewer, oil, and/or other consumables or services to consumers. A utility company may offer such services over a considerable geographic area and to a large number of consumers. Utility companies have increasingly networked their infrastructure, and considerable data is generated from measurement points throughout their systems. However, battery powered devices (BPDs) disposed in network trees (e.g., mesh network, star network, etc.) are constrained with respect to data handling rates due to the BPDs' low duty cycle listen rate required to conserve battery power (e.g., for twenty years without recharging). Application servers can generate messages at a much faster rate than the BPDs can handle. Further, downstream messages in a BPD tree can often trigger upstream message responses that increases congestion of the BPD tree. Message injection rates from the application servers to the BPD tree that are higher than the BPD tree can handle may cause high levels of contention between BPDs, increase packet failures due to packet collisions, which increases packet transmission retries attempting to successfully send a message, which in turn leads to additional contention and collision rates.

Thus, the higher message injection rates ultimately result in high levels of message failures and unreliable communications between the BPDs, the BPD trees, and/or the application servers, causing poor network performance and preventing the BPDs from conserving battery power.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components. Moreover, the figures are intended to illustrate general concepts, and not to indicate required and/or necessary elements.

FIG. 1 illustrates a block diagram showing an example message pacing system that accommodates pacing requirements of a plurality of battery powered devices (BPDs) disposed in a tree according to an example in this disclosure.

FIG. 2A illustrates a diagram showing details of an example access point according to an example in this disclosure.

FIG. 2B illustrates a diagram showing details of an example battery powered device (BPD) according to an example in this disclosure.

FIG. 3 is a flow diagram showing an example method for performing techniques of pacing messages under an access point according to an example in this disclosure.

FIG. 4 is flow diagram showing a second example method for performing techniques of pacing messages under an access point according to an example in this disclosure.

FIG. 5 is a flow diagram showing an example pacing process for performing techniques of pacing messages under an access point according to an example in this disclosure.

FIG. 6 is a flow diagram showing a second example pacing process for performing techniques of pacing messages under an access point according to an example in this disclosure.

FIG. 7 is a flow diagram showing an example buffer servicing process for performing techniques of pacing messages under an access point according to an example in this disclosure.

### DETAILED DESCRIPTION

### Overview

As discussed above, excessive message injection rates from application servers to battery power devices (BPDs) may result in high levels of message failures and unreliable communications between the BPDs, the BPD trees, and/or the application servers that cause the BPDs to increase packet transmission retries. Thus, preventing the BPDs from conserving battery power and reducing the battery power of the BPDs.

Some existing pacing mechanisms have been incorporated in server applications (e.g., back-office server applications), at an application layer of applications, and/or traditional traffic shaping mechanisms (e.g., token bucket based algorithms) may reduce messaging traffic. However, these pacing mechanisms lack coordination between each other, resulting in high levels of message failures, causing the BPDs to increase packet transmission retries attempting to successfully send messages. Thus, preventing the BPDs from conserving battery power.

This application describes message pacing management systems and methods that accommodate pacing requirements of BPDs disposed in a tree or other network structure. For example, an access point (e.g., solar powered battery access point, electric meter, gas meter, water meter, street meter, relay, proxy, etc.) may be in communication with multiple BPDs arranged in a network, such as a field area network (FAN). The BPDs have limited throughput due to their limited duty cycle designed to conserve battery power to enable the BPDs to operate over their usable life (e.g., twenty years without being recharged). The access point may serve as a proxy for the BPDs and to communicate to and from a utility communication central office via a cellular or other backhaul connection. In an example embodiment according to this disclosure, the access point may be a device that applies the pacing rules on the device's outbound traffic. For example, the access point may be one of the devices within a mesh itself and not necessarily a head and/or root of the mesh. The BPDs may be disposed in a tree structure underneath the access point, which is configured to control a pace of messages in the tree of BPDs based on a multi-level pacing mechanism designed to accommodate the pacing requirements of the limited throughput of the tree of the BPDs. For example, an access point communicatively coupled with a tree of BPDs disposed underneath the access point may control a pace of messages in the tree of BPDs based at least in part on a first limit that only allows X messages to be sent to all first hop BPDs with a period Px (e.g., 10 messages in 120 seconds), a second limit that only allows Y messages to be sent to a subtree branch of BPDs within a period Py (e.g., 2 messages in 180 seconds), and/or a further limit that only allows one message to be in flight to any given neighbor BPD at a time. The values of X, Px, Y, and Py given herein are merely examples, and in other examples different values of X, Px, Y, and Py may be used depending on the duty cycles of the access point and the various BPDs, the number of BPDs in the FAN, among other considerations. The pacing mechanism may take into consideration management of messages waiting to be placed and a message buffering process to ensure the proper ordering of message transmission occurs. The pacing mechanism may take into account an additional mechanism that allows certain time critical messages (e.g., signaling (control plane) messages used for forming and/or maintaining an extended FAN connectivity (EFC) based mesh) to be sent without applying the pacing constraints, except for the further limit of allowing only one message to be in flight to any given BPD at a time.

The access point of the network stack may be used to implement the all-inclusive pacing mechanism. To properly pace messages under the access point, there may be two pacing requirements. A first pacing requirement is to protect against high uplink contention from the 1^{st} hop neighbors of the access point (“the 1^{st} hop neighbors”). This is done by pacing the downlink messages from the access point to the 1st hop neighbors (e.g., requests from the access point that will result in uplink responses from the downstream BPDs). This will naturally limit the rate of the potential responses from 1^{st} hop nodes. A second pacing requirement is to protect each of the 1^{st} hop subtree branches (e.g., pacing of messages that go beyond a 1^{st} hop to one or more further nodes in the FAN using an extended FAN connectivity (EFC) protocol), where the EFC comprises a meshing protocol used by the BPDs. This second pacing requirement is a limit to a specific to each subtree branch, and limits the messages going to each of the 1st hop neighbors and all the BPDs underneath that 1st hop neighbor for a given period of time. This second pacing requirement includes messages having the 1^{st} hop neighbor as final destination. In other words, the second pacing requirement is a pacing per 1^{st} hop neighbor (per subtree branch). This can be thought of as a separate counter for each 1^{st} hop neighbor that counts the number of messages sent to that 1^{st} hop neighbor (and all nodes connected to it) within a predetermined period. A third requirement is that only one message can be in flight to a particular 1^{st} hop neighbor at a time. The first two pacing requirements may not apply to certain critical messages, such as signaling (control plane) messages critical for forming and/or maintaining the EFC based mesh, though the third requirement may still apply even to critical messages.

In an example, the access point may receive or generate a message to be sent to a BPD that is part of an EFC mesh managed by the access point. The access point may determine when to send the message to the BPD based at least in part on: a rule that a single message is permitted to be in flight to the BPD at time; a first pacing requirement which limits messages that can be sent to first hop neighbors of the access point to a first number of messages per a first unit of time; and a second pacing requirement which limits messages that can be sent to each subtree branch of the EFC mesh (i.e., messages that can be sent to each particular first hop neighbor and the BPDs that are connected to the particular first hop neighbor) to a second number of messages per a second unit of time. The first number of messages and the second number of messages may be the same or different from each other, and the first unit of time and the second unit of time may be the same or different from each other. In one particular example, for the first pacing requirement the first number of messages can be three and the first unit of time can be 120 seconds, and for the second pacing requirement the second number of messages can be two and the second unit of time can be 180 seconds. The access point may then send the message to the BPD at a time based at least in part on the rule, the first pacing requirement, and the second pacing requirement.

While the examples described herein describe a two-level approach to pacing, the techniques described herein are not limited to just two levels or two different pacing requirements. Rather, the two levels described in the examples herein relate to an example in which the network includes two different device types with different capabilities (e.g., an access point such as an SBAP and multiple BPDs such as gas meters, water meters, sensors, actuators, or internet of things (IoT) battery device disposed in a branched network below the access point). However, in other examples, more than two levels of pacing can be implemented. For instance, more levels could be used to implement pacing in networks comprising additional or alternative device types with different capabilities, such as street lights, parking meters, road studs, water meters, gas meters, etc. These devices may listen at different rates and may build subtrees underneath the access point or within a BPD subtree. In these instances, the access point may apply one or more additional levels (third, fourth, fifth, etc.) of individual pacing limits based on the capabilities of the devices within the given subtree. The capabilities of the access point, such as battery supply, additional power sources, processing power, number and type of transceivers, and other factors may also affect the number of pacing levels and/or the specific pacing requirements to be used for a given network. There is no conceptual limit to the number of pacing levels.

The discussion herein includes several sections. Each section is intended to be an example of techniques and/or structures, but is not intended to indicate elements which must be used and/or performed. A section entitled “Example System and Techniques” discusses example structures and implementations that can be used to accommodate pacing requirements of BPDs disposed in a tree below an access point. A section entitled “Example Methods” discusses aspects of methods operational in devices including processors, memory devices, application specific integrated circuits (ASICs), etc. In particular, the example methods may be applied to any of the techniques discussed herein, including those of the following sections.

### Example System and Techniques

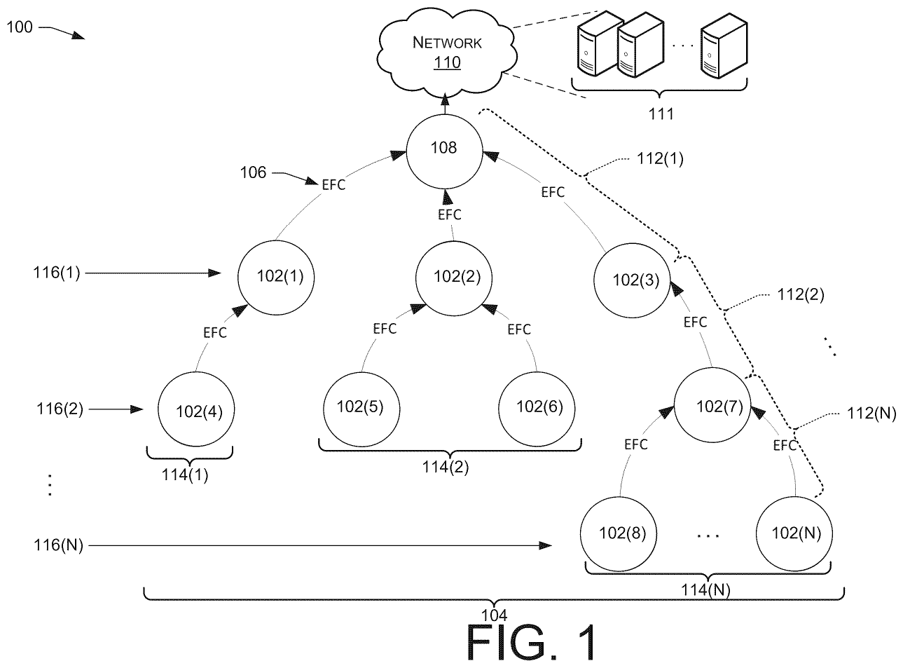

FIG. 1 illustrates a block diagram showing an example message pacing system 100 that accommodates pacing requirements of a plurality of battery powered devices (BPDs) 102(1), 102(2), 102(3), 102(4), 102(5), 102(6), 102(7), 102(8), and 102(N) disposed in a tree 104. Each of the plurality of battery powered devices 102(1)-102(N) having one or more batteries with a limited battery life (e.g., twenty years without recharging). The plurality of BPDs 102(1)-102(N) communicating in the tree 104 may be the same type of BPD having limited battery life, or the plurality of BPDs 102(1)-102(N) may be different types of BPDs having limited battery life. The plurality of BPDs 102(1)-102(N) may be any one of water meters, one or more electric meters, one or more gas meters, one or more streetlights, one or more relays, etc. running a battery mesh protocol 106 (e.g., an extended field area network connectivity (EFC)) based on messaging limitations (e.g., a listening schedule) of the plurality of BPDs 102(1)-102(N) in the tree 104.

The message pacing system 100 may include an access point 108. The access point 108 may be any type of device having a relatively high upstream and/or downstream communication speed and a tree of a plurality of BPDs having limited battery life disposed underneath the access point 108 and using the battery mesh protocol 106 in the tree. For example, the access point 108 may be any one of a solar powered battery access point, electric meter, gas meter, water meter, street meter, relay, proxy, etc. having a relatively high upstream and/or downstream communication speed with a tree of a plurality BPDs having limited battery life disposed underneath any one of the solar powered battery access point, the electric meter, the gas meter, the water meter, the street meter, the relay, the proxy, etc. and using the battery mesh protocol 106 in the tree. Here, FIG. 1 illustrates the plurality of BPDs 102(1)-102(N) having limited battery life disposed underneath the access point 108 and using the battery mesh protocol 106 in the tree 104.

FIG. 1 illustrates the access point 108 may be connected upstream to one or more networks 110. The access point 108 may be connected to one or more central offices 111 via the network 110. The central office 111 may communicate over the one or more network(s) 110, such as the Internet, with the plurality of BPDs 102(1)-102(N) disposed in the tree 104. The central office 111 may receive data from, and transmit data to, the plurality of BPDs 102(1)-102(N) disposed in the tree 104 via the access point 108. Within the tree 104, the plurality of BPDs 102(1)-102(N) communicate with each other to relay information in a downstream direction and/or an upstream direction. Accordingly, the central office 111 may establish and conduct communication through the access point 108 with the plurality of BPDs 102(1)-102(N), and may receive data from the plurality of BPDs 102(1)-102(N) through the access point 108.

The tree 104 of the plurality of BPDs 102(1)-102(N) may be a random topology having any shape. The size and shape of the tree 104 may be constrained/limited by the battery life of the plurality of BPDs 102(1)-102(N) communicating in the tree 104. For example, a maximum quantity of the plurality of BPDs 102(1)-102(N) under the access point 108 may be constrained/limited based on the battery life of the plurality of BPDs 102(1)-102(N) in the tree 104 and/or there may be a maximum distance (e.g., number of hops) of BPDs from the access point. In some examples, a maximum quantity of the plurality of BPDs 102(1)-102(N) under the access point 108 may be constrained/limited to about 50 BPDs because of the battery life of the plurality of BPDs 102(1)-102(N) and/or the battery life and/or duty cycle of the access point 108. In other examples, the number of BPDs in the tree may be greater or smaller than 50 BPDs. In examples in which the access point has a significantly larger battery and/or other sources of power (e.g., solar power generation), the number of BPDs in the network may be larger (e.g., 100 BPDs or more). In the case where the access point is a mains powered device (MPD) which is able to send and receive messages at a much higher duty cycle, then the number of BPDs under the access point may be considerably higher (e.g., 1000 BPDs or more).

Moreover, the maximum quantity of the plurality of BPDs under the access point 108 may be further constrained/limited to a maximum quantity of hops 112(1), 112(2), . . . 112(N), and/or to a maximum number of children BPDs (e.g., 102(4), 102(5), 102(6), 102(7), 102(8), 102(N), etc.) of the plurality of BPDs 102(1)-102(N) in a plurality of branches 114(1), 114(2), and 114(N) in the tree 104. For example, the maximum quantity of the plurality of BPDs under the access point 108 may be further constrained/limited to up to about 4 maximum hops with about 4 children BPDs of the plurality of BPDs 102(1)-102(N) in any one of the branches 114(1)-114(N). The maximum quantity of the plurality of BPDs 102(1)-102(N) under the access point 108, the maximum quantity of hops 112(1)-112(N), and the maximum quantity of children BPDs of the plurality of BPDs 102(1)-102(N) in the branches 114(1)-114(N) may be self-imposed constraints/limits established in the battery mesh protocol 106 based at least in part on the battery life of the particular types of the plurality of BPDs 102(1)-102(N) in the tree 104.

Thus, because these maximum quantities may be self-imposed constraints/limits based at least in part on the battery life of the particular types of the plurality of BPDs 102(1)-102(N) in the tree 104, the battery mesh protocol 106 may be configured with other (larger or smaller) self-imposed constraints/limits (e.g., higher or lower maximum quantities). For example, because of the self-imposed constraints/limits based on the battery life of the plurality of BPDs 102(1)-102(N) in the tree 104 the battery mesh protocol 106 may be configured with larger self-imposed constraints/limits in order to process larger quantities of BPDs (i.e., larger quantities than 50 BPDs), larger quantities of hops (i.e., larger quantities than 4 hops), and/or larger quantities of children BPDs (i.e., larger quantities than 4 children BPDs) when the battery life of the particular types of the plurality of BPDs 102(1)-102(N) in the tree 104 have relatively higher amounts of limited battery life.

The access point 108 may have a listening schedule that is relatively higher than a listening schedule of the plurality of BPDs 102(1)-102(N). For example, the access point 108 may have a listening schedule that is about 10 times more frequent than the plurality of BPDs 102(1)-102(N). In some examples, the access point 108 may listen about every 2 seconds while the plurality of BPDs 102(1)-102(N) may listen every 20 seconds. However, in other examples, the listening schedules of the access point 108 and/or the BPDs 102 may be more or less frequent than these examples based on, for example, their available battery capacity and/or or other sources of power. The listening schedule of the plurality of BPDs 102(1)-102(N) may be separate from the listening schedule of the access point 108. For example, the listening schedule of the plurality of BPDs 102(1)-102(N) may not be synchronized with the listening schedule of the access point 108. For example, the listening schedule of the plurality of BPDs 102(1)-102(N) may be substantially random. For example, BPD 102(1) may be currently actively listening, BPD 102(2) may begin listening a few milliseconds later than when BPD 102(1) started listening, and BPD 102(3) may begin listening a few seconds later than when BPD 102(2) started listening.

While FIG. 1 illustrates the tree 104 comprising a structure having a quantity of 3 BPDs (i.e., BPDs 102(1), 102(2), and 102(3)) disposed at a first hop level 116(1) below the access point 108, the tree 104 could comprise a structure having a substantially greater quantity of BPDs disposed at the first hop level 116(1) below the access point 108. In one example, the tree 104 may comprise a quantity of up to about 50 BPDs disposed at the first hop level 116(1) below the access point 108. In another example, the tree 104 may comprise a quantity greater than up to about 100 BPDs disposed at the first hop level 116(1) below the access point.

Moreover, while FIG. 1 illustrates the tree 104 comprising three hop levels (i.e., the first hop level 116(1), a second hop level 116(2), and a third hop level 116(N)) disposed below the access point 108, the tree 104 may comprise any number of hop levels below the access point 108. In one example, the tree 104 may comprise up to about 4 maximum hop levels below the access point 108. In another example, the tree 104 may comprise a maximum quantity of hop levels greater than 4 hop levels below the access point 108. Similar to the maximum quantity of the number of hops 112(1)-112(N) being constrained/limited based at least in part on a battery life of the particular types of the plurality of BPDs 102(1)-102(N) in the tree 104, the maximum quantity of hop levels may be constrained/limited based at least in part on a battery life of the particular types of the plurality of BPDs 102(1)-102(N) in the tree 104.

Moreover, the maximum quantity of the hops 112(1)-112(N) may be constrained/limited based at least in part on the listening schedule of the access point 108 and/or the listening schedule of the plurality of BPDs 102(1)-102(N) in the tree 104 below the access point 108. For example, and as discussed above, the access point may have a listening schedule that is about 10 times more frequent than a listening schedule of the plurality of BPDs 102(1)-102(N). Thus, in an example, where there are about 50 BPDs disposed in the first level 116(1) and listening at the 20 second interval, the access point 108 could theoretically send messages to every one of 50 BPDs in the first level 116(1) in the first 20 seconds interval. In response, each of 50 BPDs are going to turn around immediately and send messages back to the access point 108. However, the access point only has 10 listening spots based on the 1 listening schedule for every 2 seconds at the access point 108. As a result of the limited number of listening spots of the access point 108, in this example, the 50 BPDs disposed in the first level 116(1) try to respond to the access point 108 using the 10 listening spots, which causes high levels of contention between the 50 BPDs in the first level 116(1), increases message failures due to message collisions, causes high increases in message transmission retries attempting to successfully send a message, which leads to additional contention and collision rates.

Thus, to protect the access point 108 and/or the first level 116(1) of BPDs from high levels of contention, the access point 108 comprises a first pacing requirement. The first pacing requirement of the access point 108 comprising a first limit that only allows X messages to be sent to all first hop BPDs with a period Px (e.g., 10 messages in 120 seconds) from the access point 108. In this way, the first pacing requirement protects the access point 108 and/or the first level 116(1) of BPDs against high uplink contention via pacing of messages to and from 1^{st} hop BPDs. Further, the first pacing requirement may be scalable to be a higher pacing level or a lower pacing level based at least in part on a type of the access point 108. For example, the first pacing requirement may be scaled to a higher pacing level based on the type of access point having a larger listening window or the first pacing requirement may be scaled to a lower pacing level based on the type of the access point having a smaller listening window (e.g., period of time that the access point is scheduled to actively listen for transmissions from the BPDs and/or other devices).

Moving on to protecting each of 1^{st} hop subtree branches (e.g., first branch 114(1), second branch 114(2), third branch 114(N)) in the tree 104, the access point 108 comprises a second pacing requirement. The second pacing requirement of the access point 108 may be limiting a quantity of messages being sent per period toward the first branch 114(1), the second branch 114(2), and/or the third branch 114(N) to minimize a quantity of conflicts on one or more of the BPDs within each of the branches 114(1)-114(N). For example, looking at the third branch 114(N), the BPDs 102(7), 102(8), and 102(N) are listening at a relatively slower interval (e.g., listening at a 20 second interval). If the access point 108 is injecting messages into BPD 102(3) too fast, and BPD 102(3) is routing messages down to children BPDs 102(7), 102(8), and 102(N) and the children BPDs 102(7), 102(8), and 102(N) are responding back to BPD 102(3), BPD 102(3) only has the relatively slower interval (e.g., listening at a 20 second interval), not the relatively higher interval (e.g., listening at a 2 second interval) the access point 108 has, then the children BPDs 102(7), 102(8), and 102(N) build contention between them due to increases of message failures due to message collisions, which then increases message transmission retries attempting to successfully send messages to BPD 102(3). Thus, the access point 108 comprises a second pacing requirement to further restrict how many messages get injected into the third branch 114(N) to minimize a quantity of conflicts on the children BPDs 102(7), 102(8), and 102(N) within branch 114(N). Thus, the access point 108 comprises a second limit that comprises pacing of messages that go beyond the 1^{st} hop 112(1) into the first branch 114(1), the second branch 114(2), and/or the third branch 114(N). As discussed above, for example, the second pacing requirement of the access point 108 may only allow Y messages to be sent to a subtree branch of BPDs within a period Py (e.g., 2 messages in 180 seconds).

Additionally, the access point 108 may comprise one or more other limits. For example, the access point 108 may comprise a limit of only one message in-flight towards any 1^{st} hop BPD (e.g., BPDs 102(1), 102(2), 102(3), etc.), pacing shall be applied on message initiation (e.g., 1^{st} attempt) where MAC retries shall not be paced, and/or critical messages shall not be paced.

Moreover, the pacing mechanism may also take into consideration a management of messages waiting to be sent and a message buffering process to ensure the proper ordering of message transmission occurs. The buffer may be maintained by the access point 108.

Further, certain time critical messages that can be sent without applying the pacing constrains may be maintained by the access point 108. However, the access point still checks to see if there is another message already in flight to a BPD, and if there is already another message in flight to the BDP, the access point 108 will not send the critical message to prevent two messages being sent at the same time to avoid contention. However, if there is no message already in flight to the BPD, the access point will send the critical message even if the tree is at its pacing limit.

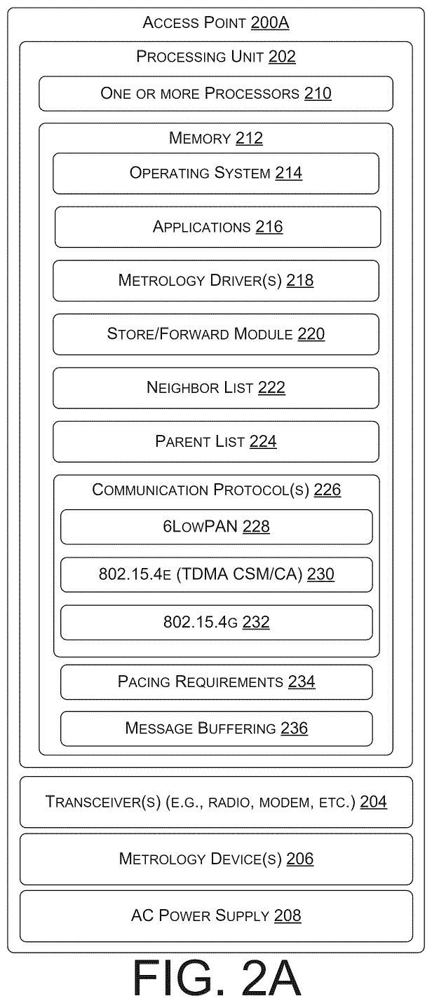

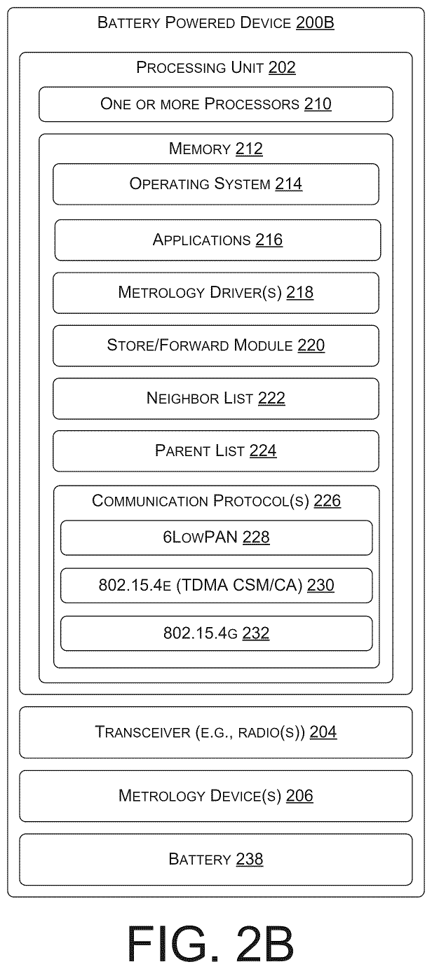

FIG. 2A is a diagram showing details of an example access point 200A. In this example, access point 200A comprises an electricity meter. However, as discussed above, an access point 200A can take numerous different forms, depending on the industry and context in which they are deployed. Different types of access point 200A may have different physical and/or logical components. For instance, utility meter access points such as that shown in FIG. 2A may have metrology components, whereas other types of access points may not.

As shown in FIG. 2A, the example access point 200A includes a processing unit 202, a transceiver 204, one or more metrology devices 206, and an alternating current (AC) power supply 208 that couples to the AC mains power line wherein the access point 200A is installed. The processing unit 202 may include one or more processors 210 and memory 212 and/or other hardware device(s), such as an application specific integrated circuit (ASIC), a gate array or other hardware-based logic device. When present, the processor(s) 210 may comprise microprocessors, central processing units, graphics processing units, or other processors usable to execute program instructions to implement the functionality described herein. Additionally or alternatively, in some examples, some or all of the functions described may be performed in hardware.

The transceiver 204 may comprises one or more hardware and/or software implemented radios to provide two-way RF communication with other network communication devices in the area network 110 and/or other computing devices via the network 110. The transceiver 204 may additionally or alternatively include a modem to provide power line communication (PLC) communication with other network communication devices that are connected to an electrical service grid.

The metrology device(s) 206 comprise the physical hardware and sensors to measure consumption data of a resource (e.g., electricity, water, or gas) at a site of the meter. In the case of an electric meter, for example, the metrology device(s) 206 may include one or more Hall effect sensors, shunts, or the like. In the case of water and gas meters, the metrology device(s) 206 may comprise various flow meters, pressure sensors, or the like. The metrology device(s) 206 may report the consumption data to the central office 111 via the transceiver 204. The consumption data may be formatted and/or packetized in a manner or protocol for transmission.

The memory 212 includes an operating system (OS) 214 and one or more applications 216 that are executable by the processor(s) 210. The memory 212 may also include one or more metrology drivers 218 configured to receive, interpret, and/or otherwise process the metrology data collected by the metrology device(s) 206. Additionally or alternatively, one or more of the applications 216 may be configured to receive and/or act on data collected by the metrology device(s) 206.

The memory 212 also includes a store/forward module 220, which is usable to temporarily store data from transmissions that are destined for another device until such a time as the data can be forwarded to the device. In some examples, the store/forward module 220 may be configured to classify, prioritize, and forward data based on a variety of criteria. Examples of criteria the store/forward module may take into account include a type of the communication (e.g., unicast or multicast), a type of device to which the data is directed (e.g., MPD, BPD, etc.), and/or a priority of the information contained in the data (e.g., command/control, alarm, consumption data, software/firmware updates, etc.).

The memory 212 also includes a neighbor list 222 and/or a parent list 224. The neighbor list 222 includes a list of devices that are in a vicinity of the access point 200A. Devices may be added to the neighbor list 222 as they are discovered by the access point 200A. The parent list 224 includes a list of devices that are parents or potential parents of the access point 200A. Potential parents are those devices that are closer to an edge or root of the area network 110 and are capable of acting as a parent of the access point 200A. In this example, the neighbor list 222 and the parent list 224 are shown as separate lists. However, in other examples, the neighbor list 222 and parent list 224 may be combined in a single list. In some examples, the neighbor list 222, parent list 224, or other list maintained by the device may include current topology information of the surrounding network (e.g., parents of parents, siblings, two-hop neighbors, etc.), availability of one or more neighbors, availability of one or more channels, or the like.

The memory 212 may also include one or more communication protocols 226. In the illustrated example, the device includes a 6LowPAN protocol stack 228, an 802.15.4e (TDMA CSM/CA) protocol stack 230, and an 802.15.4g protocol stack 232. However, in other examples, other protocol stacks may be used, depending on the networks with which the device is intended to be compatible. The communication protocols 226 describe the functionality and rules governing how the access point 200A interacts in each of the specified types of networks. For instance, the communication protocols 226 described in this disclosure cause MPDs and BPDs to operate in ways that minimize the battery consumption of BPDs when they are connected to these types of networks.

The memory 212 may also include one or more pacing requirements 234 and/or one or more message buffering processes 236. In the illustrated example, the access point 200A may take into consideration a management of messages waiting to be sent and message buffering to ensure proper ordering of message transmission occurs.

FIG. 2B is a diagram showing details of an example battery powered device, BPD 200B. In this example, BPD 200B comprises a water meter or gas meter. However, as discussed above, BPDs can take numerous different forms, depending on the industry and context in which they are deployed. Different types of BPDs may have different physical and/or logical components. For instance, utility meter BPDs such as that shown in FIG. 2B may have metrology components, whereas other types of BPDs may not.

The BPD 200B of FIG. 2B is similar in many respects to the access point 200A. To the extent that the BPD 200B and access point 200A include the same or similar components, the functions will not be repeated here. Therefore, the following discussion of the BPD 200B focuses on the differences between the BPD 200B and the access point 200A. However, the differences highlighted below should not be considered to be exhaustive. One primary difference between the access point 200A and the BPD 200B is that the BPD 200B includes a battery 238 instead of the mains power supply 208. The specific characteristics of the battery 238 may vary widely depending on the type of BPD. By way of example and not limitation, the battery 238 of the example water or gas meter of FIG. 2B may comprise a 3-volt Lithium Thionyl Chloride battery having an internal impedance rated at 130 Ohms or a 3 volt Lithium Manganese battery having an internal impedance rated at 15 Ohms.

Also, in some examples, even components with similar functions may be different for access points than for BPDs due to the different constraints. As one example, while both access points and BPDs have transceivers, the specific transceivers used may be different. For instance, an access point transceiver may include a PLC modem while a BPD transceiver does not because the BPD is not connected to an electrical power line that could be used for PLC communications. Additionally or alternatively, a BPD transceiver may employ a lower power RF radio to minimize energy consumption.

Other differences between the access point 200A and the BPD 200B relate to the functionality of the store/forward module 220. In the case of the access point 200A, the store/forward module 220 may only act on the downstream traffic directed to BPDs (i.e., traffic in the direction from the access point 200A to its BPD children). In the case of the BPD 200B, the store/forward module 220 acts on both upstream and downstream traffic, but may only be used when the BPD 200B is acting as a BPD relay. When the BPD 200B is not acting as a relay, it is not receiving transmissions that are intended for other devices so it need not use the store/forward module 220. Also, when the BPD 200B serves as a relay, the store/forward module 220 additionally takes into account the duty cycle of the BPD 200B due to characteristics of the battery 238 in determining when to forward transmissions.

The memory 212 of the access point 200A and BPD 200B is shown to include software functionality configured as one or more “modules.” However, the modules are intended to represent example divisions of the software for purposes of discussion, and are not intended to represent any type of requirement or required method, manner or necessary organization. Accordingly, while various “modules” are discussed, their functionality and/or similar functionality could be arranged differently (e.g., combined into a fewer number of modules, broken into a larger number of modules, etc.).

While detailed examples of certain computing devices (e.g., access point 200A and BPD 200B) are described above, it should be understood that even those computing devices not described in detail may include one or more processors and memory storing processor executable instructions to implement the functionalities they are described as performing. Certain computing devices may additionally or alternatively include one or more hardware components (e.g., application specific integrated circuits, field programmable gate arrays, systems on a chip, and the like) to implement some or all of the functionalities they are described as performing.

The various memories described herein are examples of computer-readable media. Computer-readable media may take the form of volatile memory, such as random access memory (RAM) and/or non-volatile memory, such as read only memory (ROM) or flash RAM. Computer-readable media devices include volatile and non-volatile, removable and non-removable media implemented in any method or technology for storage of information such as computer-readable instructions, data structures, program modules, or other data for execution by one or more processors of a computing device. Examples of computer-readable media include, but are not limited to, phase change memory (PRAM), static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transitory medium that can be used to store information for access by a computing device.

As defined herein, computer-readable media does not include transitory media, such as modulated data signals and carrier waves, and/or signals.

### Example Methods

In some examples of the techniques discussed herein, the methods of operation may be performed by software defined on memory and/or application specific integrated circuits (ASIC) as discussed above.

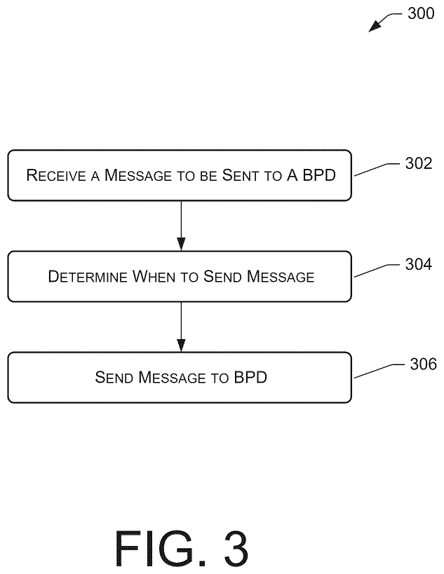

FIG. 3 is a flow diagram showing an example method 300 for performing techniques of pacing messages under an access point (e.g., access point 108) communicatively coupled with a tree 104 of battery powered devices (BPDs) (e.g., battery powered devices 102(1)-102(N)).

At operation 302, the access point may receive a message to be sent to a BPD of the BPDs.

At operation 304, the access point may determine when to send the message to the BPD based at least in part on: a rule that a single message is permitted to be in flight to the BPD at a time; a first pacing requirement which limits messages that can be sent to first hop neighbors of the access point to a first number of messages per unit of time; and a second pacing requirement which limits messages that can be sent to BPDs beyond the first hop neighbors of the access point to a second number of messages, smaller than the first number of messages, per unit of time.

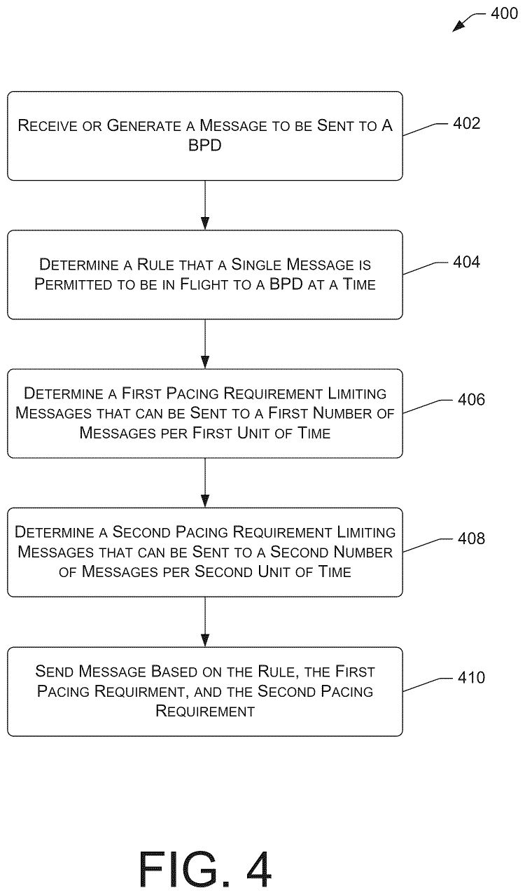

At operation 306, the access point may send the message to the BPD at a time based at least in part on the rule, the first pacing requirement, and the second pacing requirement. The examples of FIG. 3 can be used in combination with the examples of FIGS. 4, 5, 6, and/or 7.

FIG. 4 is a flow diagram showing a second example method 400 for performing techniques of pacing messages under an access point (e.g., access point 108) communicatively coupled with a tree (e.g., tree 104) of battery powered devices (BPDs) (e.g., battery powered devices 102(1)-102(N)).

At operation 402, the access point may receive or generate a message to be sent to a BPD of the BPDs.

At operation 404, the access point may determine a rule that a single message is permitted to be in flight to the BPD at a time.

At operation 406, the access point may determine a first pacing requirement which limits messages that can be sent by the access point to first hop neighbors of the access point (e.g., BPDs 102(1), 102(2), and 102(3)) disposed at the first hop level 116(1) below the access point 108) to a first number of messages per first unit of time.

At operation 408, the access point may determine a second pacing requirement which limits messages that can be sent to each branch in the tree (e.g., plurality of branches 114(1), 114(2), and 114(N) in the tree 104) in the network, each branch in the network including a particular first hop neighbor of the access point and all BPDs downstream of the particular first hop neighbor, to a second number of messages per second unit of time.

At operation 410, the access point may send the message to the BPD at a time based at least in part on the rule, the first pacing requirement, and the second pacing requirement.

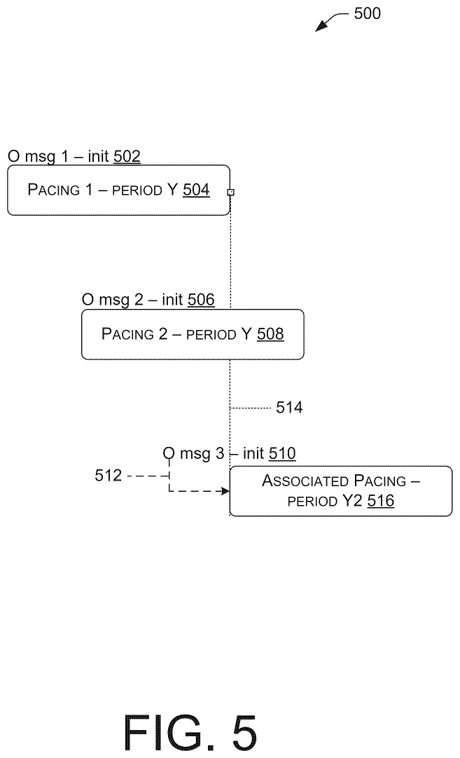

FIG. 5 is a flow diagram showing an example pacing process 500 for performing techniques of pacing messages under an access point (e.g., access point 108) communicatively coupled with a network tree (e.g., tree 104) of battery powered devices (BPDs) (e.g., battery powered devices 102(1)-102(N)) according to an example in this disclosure.

For simplicity, the example pacing process 500 assumes that the listening window of a destination BPD is imminent once the message is good to go according to the pacing rules. Here, in the example pacing process 500 illustrated in FIG. 5 no more than X messages in period Y are allowed to be sent, where X is equal to two, for example. The example pacing process 500 limits the number of messages that can be initiated in a given period of time (i.e., X messages in Y minutes). As illustrated in FIG. 5, the chosen pacing mechanism of X messages initiated to be sent in Y amount of time means that there is a timeout period or an expiration time for the number of messages that are allowed to be active.

Here, in the example pacing process 500 the pacing mechanism is for two messages in period Y. The pacing process 500 may begin at operation 502, which represents a first message initiation (i.e., message 1 initiation). When message 1 is initiated, there are no active pacing periods. Accordingly, message 1 can immediately start the transmission process and operation 504 may follow operation 502, where operation 504 represents activating a 1^{st} pacing period Y element.

Operation 504 may be followed by operation 506, which represents a second message initiation (i.e., message 2 initiation). Here, when message 2 is initiated, assuming message 1 is done transmitting in case message 2 is destined to a same neighbor, only 1 pacing period is active (i.e., operation 504, pacing 1—period Y), therefore message 2 can immediately start the transmission process and operation 508 may follow operation 506, where operation 508 represents activating a 2^{nd} pacing period Y element.

Operation 508 may be followed by operation 510, which represents a third message initiation (i.e., message 3 initiation). Here, when message 3 is initiated, assuming message 2 is done transmitting in case it is destined to the same neighbor, there are already two active pacing periods (i.e., operation 504, pacing 1—period Y; and operation 508, pacing 2—period Y). Therefore, message 3 cannot begin the transmission process until the 1^{st} pacing period Y (i.e., operation 504, pacing 1—period Y) expires. Thus, operation 510 is followed by operation 512, which represents a delay until the 1^{st} pacing period Y expires at operation 504. (Operations 512 and 514 are shown with dashed lines representing the delay until the 1^{st} pacing period Y expires).

Then, when the 1^{st} pacing period Y expires at operation 514, message 3 can start the transmission process and an associated pacing period Y element is activated at operation 516. Here, in the example pacing process 500, if the maximum number of pacing array elements is two pacing array elements, then this newly activated associated pacing period Y (i.e., operation 516) reuses the 1^{st} pacing period Y element (e.g., reuses operation 504) that has expired at operation 514.

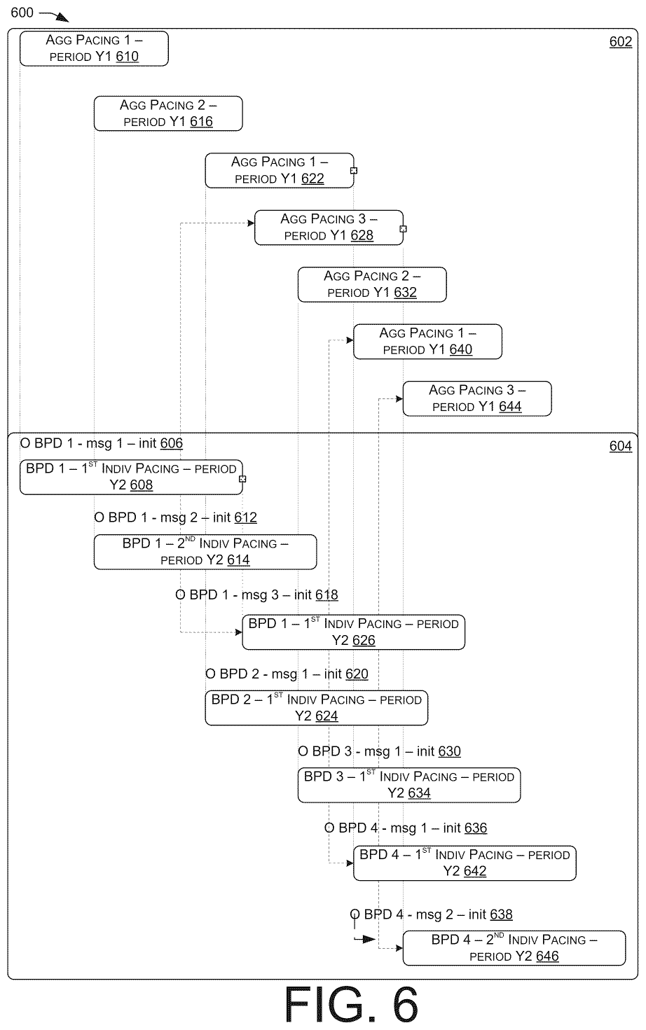

Subsequently, this means there are only two pacing periods associated with this process since only two messages are allowed to be activated for the transmission process in period Y. If this process was for N messages in period Y then there would be N pacing periods. As discussed in detail below, with regard to FIG. 6, the pacing requirements include an aggregate pacing level of the number of initiated messages to any children BPDs supported by the access point, to support an uplink response rate and an individual pacing level for the 1^{st} hop BPDs allowing for response, routing, and memory management in the 1^{st} hop BPDs and the children BPDs underneath the 1^{st} hop BPDs. The examples of FIG. 4 can be used in combination with the examples of FIGS. 3, 5, 6, and/or 7.

FIG. 6 is a flow diagram showing a second example pacing process 600 for performing techniques of pacing messages under an access point (e.g., access point 108) communicatively coupled with a network tree (e.g., tree 104) of battery powered devices (BPDs) (e.g., battery powered devices 102(1)-102(N)) according to an example in this disclosure.

The pacing process 600 may define a multi-level pacing process comprising aggregate pacing 602 (e.g., first pacing requirement) and/or individual pacing 604 (e.g., second pacing requirement). The aggregate pacing 602 may comprise the access point controlling a pace of messages in the tree of BPDs based at least in part on a first limit that only allows X messages to be sent to all first hop BPDs with a period Px (e.g., 10 messages in 120 seconds). The individual pacing 604 may comprise individual neighbor (BPD 1^{st} hop child) pacing of Y messages in period Py (e.g., 2 messages in 180 seconds) to the same neighbor (BPD 1^{st} hop child) regardless of the “final destination. ” The primary limitation of the aggregate pacing 602 is the access point listen rate and its upstream message capacity. The primary limitation of the individual pacing 604 are the BPD listen rates and the branch (e.g., branches 114(1)-114(N)) subtree communications capacity. The aggregate pacing 602 is configured to allow more messages during its pacing period compared to the individual pacing 604. Moreover, the pacing process 600 may also comprise a rule that a single message is permitted to be in flight to a BPD at time.

FIG. 6 illustrates how the aggregate pacing 602 and the individual pacing 604 interact with each other in order to pace messages under the access point (e.g., access point 108 or 200A). In the example pacing process 600 of FIG. 6, the illustrated blocks represent pacing element operations. Each of the pacing element operations comprises a pacing element period. For example, each of the pacing elements associated with the aggregate pacing 602 may comprise a period Y1 (e.g., 120 seconds), and each of the pacing elements associated with the individual pacing 604 may comprise a period Y2 (e.g., 180 seconds), greater than the pacing period Y1 associated with the aggregate pacing 602.

In the example pacing process 600, the pacing process 600 assumes there have been no recent downstream messages (e.g., no messages in flight) and no pacing periods are active, both aggregately and individually. The pacing process 600 may begin at operation 606, which represents a first message initiated by BPD 1 (BPD 1 message 1 initiation). Operation 606 may be followed by operation 608 and operation 610. Operation 608 represents the BPD 1 1^{st} individual pacing period being activated. Operation 610 represents the 1^{st} aggregate pacing period being activated. According to the individual pacing 604, operation 608 may be activated since there are no preexisting pacing periods individually. According to the aggregate pacing 602, operation 610 may be activated since there are no preexisting pacing periods aggregately. No delays are applied, and BPD 1 message 1 can start the transmission process.

Operation 612 may follow operation 608 and/or 610. Operation 612 represents a BPD 1 message 2 being initiated. Here, the example pacing process 600 assumes that BPD 1 message 1 has already successfully been transmitted and an ACK received prior to BPD 1 message 2 being initiated.

Operations 614 and/or 616 may follow operation 612. Operation 614 represents a BPD 1 2^{nd} individual pacing period being activated for BPD 1 since the BPD 1 2^{nd} individual pacing period is available to use according to the individual pacing 604. Operation 616 represents a 2^{nd} aggregate pacing period being activated since the 2^{nd} aggregate pacing period is available to use according to the aggregate pacing 602. No delays are applied, and BD1 message 2 can start the transmission process. Then, the 1^{st} aggregate pacing period (i.e., operation 610) expires. At this point, the pacing period status comprises 1 aggregate pacing period (i.e., operation 616) out of 3 aggregate pacing periods being activated and both individual pacing periods (i.e., operations 608 and 614) are activated for BPD 1.

Operation 614 and/or operation 616 may be followed by operation 618. Operation 618 represents a BPD 1 message 3 being initiated while both of the BPD 1 individual pacing periods (i.e., operations 608 and 614) are still active but only one aggregate pacing period (i.e., operation 616) is still active. Thus, according to the aggregate pacing 602 and the individual pacing 604, the BPD 1 message 3 is delayed until the 1^{st} BPD 1 individual pacing period (i.e., operation 608) expires (the earliest expiring pacing period). At this time, no aggregate pacing period is activated at this point since the BPD 1 message 3 is delayed.

Operation 618 may be followed by operation 620. Operation 620 represents a BPD 2 message 1 being initiated while both of the BPD 1 individual pacing periods are still active but only one aggregate pacing period is still active. Thus, according to the aggregate pacing 602 and the individual pacing 604, the BPD 2 message 1 can start the transmission process.

Operation 620 may be followed by operation 622 and/or 624. Operation 622 represents the 1^{st} aggregate period being activated as it is available. Operation 624 represents the BPD 2 1^{st} individual pacing period being activated.

Here, in the example pacing process 600, the BDP 1 1^{st} individual pacing period (i.e., operation 608) expires and becomes available. Consequently, the BPD 1 message 3 (i.e., operation 618) can start the transmission process.

Operation 622 and/or operation 624 may be followed by operation 626 and/or operation 628. Operation 626 represents the BPD 1 1^{st} individual pacing period being activated. Operation 628 represents the 3^{rd} aggregate pacing period being activated. Operations 626 and 628 are being activated since both are available to be activated according to the aggregate pacing 602 and the individual pacing 604.

Here, in the example pacing process 600, the 2^{nd} aggregate pacing period (i.e., operation 616) expires. At this point, the pacing periods status comprises: 2 out of 3 aggregate pacing periods are activated (i.e., operations 622 and 628), the 2^{nd} aggregate pacing period is available; both individual pacing periods (i.e., operations 608 and 614) are activated for BPD 1; and only 1 individual pacing period (i.e., operation 624) is activated for BPD 2, 1 individual pacing period is still available for BPD 2.

The pacing process 600 may continue with operation 630, which represents a BPD 3 message 1 being initiated. Consequently, according to the aggregate pacing 602 and the individual pacing 604, operation 630 may be followed by operation 632 and/or operation 634. Operation 632 represents the 2^{nd} aggregate pacing period being activated. Operation 634 represents the BPD 3 1^{st} individual pacing period being activated. Here, in the example pacing process 600, the BPD 3 message 1 can start the transmission process, and all 3 aggregate pacing periods are activated.

The pacing process 600 may continue with operation 636, which represents a BPD 4 message 1 being initiated. Here, according to the aggregate pacing 602 and the individual pacing 604, despite that both of the BPD 4 individual pacing periods are still available, BPD 4 message 1 is delayed because no aggregate pacing periods are available. Consequently, BPD 4 message 1 is delayed until the earliest expiring aggregate pacing period, namely the 1^{st} aggregate pacing period (i.e., operation 622).

Operation 636 may be followed by operation 638. Operation 638 representing a BPD 4 message 2 being initiated. However, at this point in the example pacing process 600, the BPD 4 message 1 is still in progress for transmission and because of the limit of only one message being in-flight towards any 1^{st} hop BPD pacing is applied for BPD 4. Accordingly, BPD 4 message 2 stays in a message buffer until the end of the transmission process of BPD 4 message 1.

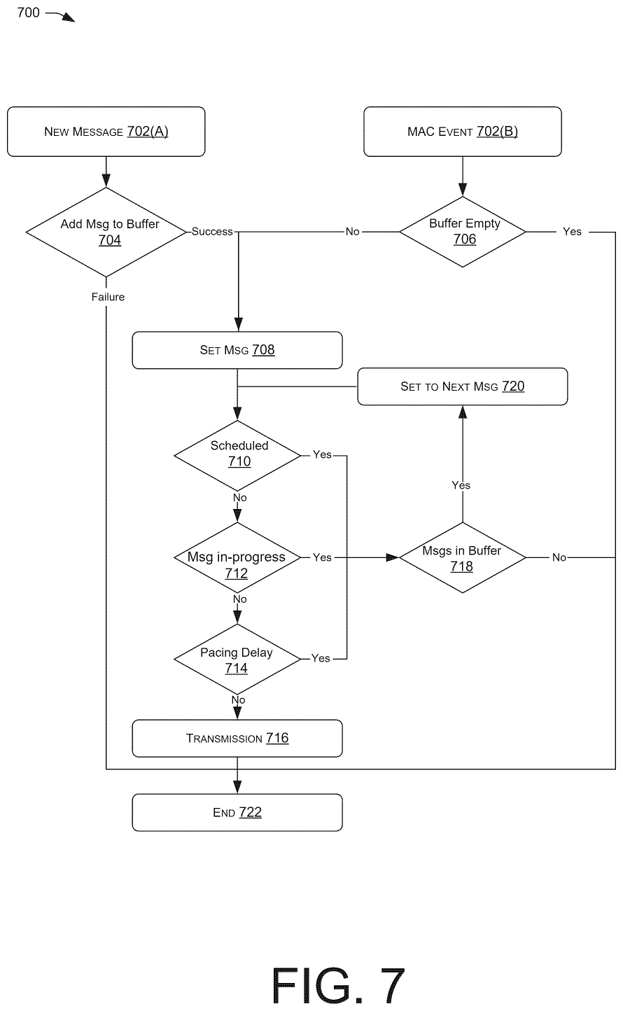

For example, the MAC of the access point may implement a message buffer for the purpose of storing multiple messages while attempting to forward the messages to neighboring devices. This enables the possibility of running multiple unicast transmission processes in parallel, each for a neighbor destination. In some examples, the message buffer may also store local access messages. Messages contained in the buffer are serviced based on the order of their arrival. If two or more messages are destined to the same neighbor, then the messages are serviced based on the oldest message first. Only one message to that destination shall be in progress in the transmission process. Messages addressed to different neighbors (EFC 1^{st} hop child) could be in progress at the same time in the transmission process, the next higher layer (NHL) is responsible of arbitrating them according to their start time. The management and service of the message buffer is described in more detail below and illustrated in FIG. 7.

The pacing process 600 may continue with operation 640 and/or 642. Here, in the example pacing process 600, because the 1^{st} aggregate pacing period expires (i.e., operation 622), the BPD 4 message 1 can start the transmission process according to the aggregate pacing 602 and the individual pacing 604. Thus, with the start of the transmission process of BPD 4 message 1, operation 640 represents the 1^{st} aggregate pacing period being activated for the start of the transmission process of the BPD 4 message 1. Similarly, with the start of the transmission process of BPD 4 message 1, operation 642 represents a BPD 4 1^{st} individual pacing period being started for the starting of the transmission process of BPD 4 message 1.

Then, when BPD 4 message 1 completes the transmission process, the BPD 4 message 2 is serviced from the buffer and re-initiated. According to the individual pacing rules, BPD 4 message 2 does not need to be delayed as a 2^{nd} BPD 4 individual pacing period is not active. However, all 3 aggregate pacing periods (i.e., operations 622, 628, and 632) are active at this point, hence, BPD 4 message 2 is delayed until the end of the earliest aggregate pacing window (i.e., operation 622). Operation 644 and/or operation 646 may follow operations 640 and/or 642. Here, in the example pacing process 600, because the 3^{rd} aggregate pacing period expires (i.e., operation 628), the BPD 4 message 2 can start the transmission process. Thus, with the start of the transmission process of BPD 4 message 2, operation 644 represents the 3^{rd} aggregate pacing period being activated for the start of the transmission process of the BPD 4 message 2. Similarly, with the start of the transmission process of BPD 4 message 2, operation 646 represents a BPD 4 2^{nd} individual pacing period being started for the start of the transmission process of BPD 4 message 2.

At this point in the example pacing process 600, the status of the pacing periods are as follows: all 3 aggregate periods (i.e., operations 632, 640, and 644) are activated, no available aggregate pacing periods are available; 1 individual pacing period is activated for BPD 1 (i.e., operation 626); 1 individual pacing period is activated for BPD 2 (i.e., operation 624); 1 individual pacing period is activated for BPD 3 (i.e., operation 634); and 2 individual pacing periods are activated for BPD 4 (i.e., operations 642 and 646).

Because the individual pacing period value is greater than the aggregate pacing period value, the pacing process 600 could end up with a total number of activated individual periods that is greater than the number of activated aggregate periods. Accordingly, if the implementation is based on an individual pacing array to track both individual and aggregate pacing, then the size of that array need not be limited to the maximum number of aggregate pacing periods that are allowed to be activated at the same time. The examples of FIG. 6 can be used in combination with the examples of FIGS. 3, 4, 5, and/or 7.

FIG. 7 is a flow diagram showing an example buffer servicing process 700 for performing techniques of pacing messages under an access point (e.g., access point 108) communicatively coupled with a network tree (e.g., tree 104) of battery powered devices (BPDs) (e.g., battery powered devices 102(1)-102(N)) according to an example in this disclosure.

The MAC of the access point may implement a message buffer for the purpose of storing multiple messages while attempting to forward the messages to neighboring devices. This enables the possibility of running multiple unicast transmission processes in parallel, each for a neighbor destination. In some examples, the message buffer may also store local access messages. Messages contained in the buffer are serviced based on the order of their arrival. If two or more messages are destined to the same neighbor, then the messages are serviced based on the oldest message first. Only one message to that destination shall be in progress in the transmission process. Messages addressed to different neighbors (BPD 1^{st} hop child) could be in progress at the same time in the transmission process, the next higher layer (NHL) may be responsible of arbitrating them according to their start time. This section describes the pre-scheduling process that the MAC executes to select a message from the buffer to initiate for transmission using the unicast transmission process and hence to schedule with the NHL, where the NHL in the context of an open systems interconnection (OSI) network model layering may be the next higher layer with respect to a layer of interest. In an example embodiment according to this disclosure, the NHL of the MAC may be the link layer control (LLC).

The buffer servicing process 700 may begin at operation 702(A) and/or operation 702(B). Operation 702(A) represents new message arrival events. For example, when the MAC has received a request (e.g., data request) with a unicast destination address, when the MAC is transmitting a multicast message using individual unicast messages and the unicast service, when the MAC is sending an affiliation request or affiliation response, or asynchronous affiliation response message, when the MAC is sending an association request or association response message, and/or when the MAC is forwarding a data message. Operation 702(B) represents MAC message related processing events. For example, the “earliest pacing element expiry timer” expires, and/or when a message completes the unicast transmission process.

If a new message arrival event occurs at operation 702(A), then the buffer servicing process 700 may continue with operation 704, which represents adding a new message to the buffer process. At operation 704, if the new message is successfully added to the buffer process, then operation 704 may be followed by operation 708, which represents setting the new message to the 1^{st} message at the head of the buffer. However, if the new message is not successfully added to the buffer process at operation 704, then operation 704 may be followed by operation 722, which represents the end of the buffer servicing process for the new message.

If a MAC message related processing event occurs at operation 702(B), then the buffer servicing process 700 may continue with operation 706, which represents determining if buffers are empty. If at operation 706 it is determined the buffer is empty, then operation 706 may be followed by operation 722, which represents the end of the buffer servicing process for the new message. If at operation 706 it is determined that there is at least one message in the buffer, then operation 706 may be followed by operation 708, which represents setting the new message to the 1^{st} message at the head of the buffer.

Operation 708 may be followed by operation 710, which represents checking if the new message has been already scheduled. If at operation 710 the new message is already scheduled, then operation 710 may be followed by operation 718, which represents checking if there are more messages in the buffer.

If at operation 718 there are more messages in the buffer, then operation 718 may be followed by operation 720, which represents setting the new message to the next message to process from the buffer. When, at operation 720, the new message is set to the next message to process from the buffer, then operation 720 may be followed by operation 710. However, if at operation 718 there are no more messages in the buffer, then operation 718 may be followed by operation 722, which represents the end of the buffer servicing process 700 for the new message.

Continuing with the example buffer servicing process 700 at operation 710, if at operation 710 the new message is not already scheduled, then operation 710 may be followed by operation 712, which represents checking if there is already an in-progress message for the same destination as the destination of the new message. If at operation 712 it is determined there is an in-progress message for the same destination as the destination of the new message, then operation 712 may be followed by operation 718. If at operation 712 it is determined that there is not an in-progress message for the same destination as the destination of the new message, then operation 712 may be followed by operation 714, which represents checking if a pacing delay is needed.

If at operation 714 the pacing delay is not need, then operation 714 may be followed by operation 716, which represents starting the unicast transmission process of the new message. Here at operation 714, it may be determined that the pacing delay is not needed if MAC pacing is false, and/or if the N^{th} neighbor type of the destination of the new message is set to “Parent.” If at operation 714 the pacing delay is needed, then operation 714 may be followed by operation 718. Here at operation 714, the pacing rules are applied and the buffer servicing process 700 can execute the following: if the total number of valid elements (neighbor address different than 0) is less than MAC pacing array size, then continue to the next check. Otherwise, MAC pacing array size is full and the buffer servicing process 700 continues to operation 718; and/or determine if a pacing delay is needed by executing a pacing rules check and delay calculation procedure that returns a variable pacing delay value that is equal or greater than zero, where if variable pacing delay>0, then go to operation 718, else if variable pacing delay=0, then go to operation 716. Here, operation 716 may be followed by operation 722, which represents the end of the buffer servicing process for the new message. The examples of FIG. 7 can be used in combination with the examples of FIGS. 3, 4, 5, and/or 6.

### Example Clauses

A. A method of pacing messages in a network of battery powered devices (BPDs), the method comprising: receiving or generating, at an access point, a message to be sent to a BPD of the BPDs; determining, by the access point, when to send the message to the BPD based at least in part on: a first pacing requirement which limits messages that can be sent by the access point to first hop neighbors of the access point to a first number of messages per first unit of time; and a second pacing requirement which limits messages that can be sent to each branch in the network, each branch in the network including a particular first hop neighbor of the access point and all BPDs downstream of the particular first hop neighbor, to a second number of messages per second unit of time; and sending the message to the BPD based at least in part on the first pacing requirement and the second pacing requirement.

B. The method as paragraph A recites, further comprising: determining, by the access point, when to send the message to the BPD based at least in part on a rule that a single message is permitted to be in flight to the BPD at a time; and wherein sending the message to the BPD is further based at least in part on the rule.

C. The method as paragraph A or B recites, wherein determining when to send the message to the BPD is further based at least in part on a queue of messages to be sent to the BPDs in the network.

D. The method as any one of paragraphs A through C recite, wherein determining when to send the message to the BPD is further based at least in part on a buffer servicing process, which determines when to send the message to the BPD from among multiple messages in the queue of messages to be sent to the BPDs in the network.

E. The method as paragraph D recites, wherein a medium access control (MAC) of the access point implements the buffer servicing process.

F. The method paragraph E recites, wherein determining when to send the message to the BPD is further based at least in part on a schedule of listening windows of the BPDs in the network.

G. The method as any one of paragraphs A through F recite, wherein the access point comprises a solar powered battery access point, an electric meter, a gas meter, a water meter, a street meter, a relay, or a proxy.

H. The method as any one of paragraphs A through G recite, wherein the access point includes at least one of a power generation source or a mains power supply, and the BPD omits any power generation source or mains power supply.

I. The method as any one of paragraphs A through H recite, wherein the BPD comprises a gas meter, a water meter, a sensor, an actuator, or internet of things (IoT) battery device.

J. The method as any one of paragraphs A through I recite, wherein the first pacing requirement comprises 10 messages in 120 seconds and the second pacing requirement comprises 2 messages in 180 seconds.

K. A non-transitory computer-readable storage media storing computer-executable instructions that, when executed on one or more processors, cause the one or more processors to perform acts comprising: receiving or generating, at a first device of devices in a network, a message to be sent to a second device of the devices in the network; determining, by the first device, when to send the message to the second device based at least in part on: a first pacing requirement which limits messages that can be sent by the first device to first hop neighbors of the first device to a first number of messages per first unit of time; and a second pacing requirement which limits messages that can be sent to each branch in the network to a second number of messages per second unit of time; and sending the message to the second device based at least in part on the first pacing requirement and the second pacing requirement.

L. The non-transitory computer-readable storage media as paragraph K recites, causing the one or more processors to perform additional acts comprising: determining, by the first device, when to send the message to the second device based at least in part on a rule that a single message is permitted to be in flight to the second device at a time; and wherein sending the message to the second device is further based at least in part on the rule.

M. The non-transitory computer-readable storage media as paragraphs L or M recite, wherein determining when to send the message to the second device is further based at least in part on a queue of messages to be sent to the devices in the network.

N. The non-transitory computer-readable storage media as paragraph M recites, wherein determining when to send the message to the second device is further based at least in part on a buffer servicing process, which determines when to send the message to the second device from among multiple messages in the queue of messages to be sent to the devices in the network.

O. The non-transitory computer-readable storage media as paragraph N recites, wherein a medium access control (MAC) of the first device implements the buffer servicing process.

P. The non-transitory computer-readable storage media as any one of paragraphs K through O recite, wherein the first device includes a mains power supply, and the second device omits any power generation source or mains power supply.

Q. The non-transitory computer-readable storage media as any one of paragraphs K through P recite, wherein determining when to send the message to the second device is further based at least in part on a schedule of listening windows of the devices in the network.

R. The non-transitory computer-readable storage media as any one of paragraphs K through Q recite, wherein the first pacing requirement comprises 10 messages in 120 seconds and the second pacing requirement comprises 2 messages in 180 seconds.

S. A method of pacing messages in a network of devices, the method comprising: receiving or generating a message to be sent to a device of the devices in the network; determining when to send the message to the device based at least in part on: a rule that a single message is permitted to be in flight to any given neighbor device of the devices within the network at a time; an aggregate pacing requirement which limits messages that can be sent to first hop neighbor devices of the devices within the network to a first number of messages per first unit of time; and an individual pacing requirement which limits messages that can be sent to individual neighbor devices of the devices within the network to a second number of messages per second unit of time; and sending the message to the device based at least in part on the rule, the aggregate pacing requirement, and the individual pacing requirement.

T. The method as paragraph S recites, further comprising: determining when to send the message to the device based at least in part on a rule that a single message is permitted to be in flight to any given neighbor device of the devices within the network at a time; and wherein sending the message to the device is further based at least in part on the rule.

U. The method as paragraphs S or T recite, wherein determining when to send the message to the device is further based at least in part on a queue of messages to be sent to the devices in the network.

V. The method as paragraph U recites, wherein determining when to send the message to the device is further based at least in part on a buffer servicing process, which determines when to send the message to the device from among multiple messages in the queue of messages to be sent to the devices in the network.

W. The method as paragraph V recites, wherein a medium access control (MAC) of at least one of the devices in the network implements the buffer servicing process.

X. The method as any one of paragraphs S through W recite, wherein determining when to send the message to the device is further based at least in part on a schedule of listening windows of the devices in the network.

Y. The method as any one of paragraphs S through X recite, wherein the aggregate pacing requirement comprises 10 messages in 120 seconds and the individual pacing requirement comprises 2 messages in 180 seconds.

Z. A metering device comprising: one or more processors; and memory storing instructions that, when executed by the one or more processors, configure the metering device to perform operations comprising: receiving or generating a message to be sent to a device of devices in a network; determining when to send the message to the device based at least in part on: an aggregate pacing requirement which limits messages that can be sent to first hop neighbor devices of the devices within the network to a first number of messages per first unit of time; and an individual pacing requirement which limits messages that can be sent to individual neighbor devices of the devices within the network to a second number of messages per second unit of time; and sending the message to the device based at least in part on the aggregate pacing requirement and the individual pacing requirement.

AA. The metering device as paragraph Z recites, wherein the memory storing instructions that, when executed by the one or more processors, configure the metering device to perform additional operations comprising determining when to send the message to the device based at least in part on a rule that a single message is permitted to be in flight to any given neighbor device of the devices within the network at a time; and wherein sending the message to the device is further based at least in part on the rule.

BB. The metering device as paragraphs Z or AA recite, wherein determining when to send the message to the device is further based at least in part on a queue of messages to be sent to the devices in the network.

CC. The metering device as paragraph BB recites, wherein determining when to send the message to the device is further based at least in part on a buffer servicing process, which determines when to send the message to the device from among multiple messages in the queue of messages to be sent to the devices in the network.

DD. The metering device as paragraph CC recites, further comprising a medium access control (MAC), and wherein the MAC of the metering device implements the buffer servicing process.

EE. The metering device as any one of paragraphs Z through DD recite, wherein determining when to send the message to the device is further based at least in part on a schedule of listening windows of the devices in the network.

FF. A method of pacing upstream messages in a network of battery powered devices (BPDs), the method comprising: receiving or generating, at a BPD of the BPDs, a message to be sent to an upstream node of the network; determining, by the BPD, when to send the message to the BPD based at least in part on one or more pacing requirements limiting a number of upstream messages that can be sent per unit of time; and sending the message to the upstream node based at least in part on the one or more pacing requirements.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method of pacing messages in a network of battery powered devices (BPDs), the method comprising:
receiving or generating, at an access point, a message to be sent to a BPD of the BPDs;
determining, by the access point, when to send the message to the BPD based at least in part on:
a first pacing requirement which limits messages that can be sent by the access point to first hop neighbors of the access point to a first number of messages per first unit of time; and
a second pacing requirement which limits messages that can be sent to each branch in the network, each branch in the network including a particular first hop neighbor of the access point and all BPDs downstream of the particular first hop neighbor, to a second number of messages per second unit of time; and
sending the message to the BPD based at least in part on the first pacing requirement and the second pacing requirement.

2. The method of claim 1, further comprising:
determining, by the access point, when to send the message to the BPD based at least in part on a rule that a single message is permitted to be in flight to the BPD at a time; and
wherein sending the message to the BPD is further based at least in part on the rule.

3. The method of claim 1, wherein determining when to send the message to the BPD is further based at least in part on a queue of messages to be sent to the BPDs in the network.

4. The method of claim 3, wherein determining when to send the message to the BPD is further based at least in part on a buffer servicing process, which determines when to send the message to the BPD from among multiple messages in the queue of messages to be sent to the BPDs in the network.

5. The method of claim 4, wherein a medium access control (MAC) of the access point implements the buffer servicing process.

6. The method of claim 1, wherein determining when to send the message to the BPD is further based at least in part on a schedule of listening windows of the BPDs in the network.

7. The method of claim 1, wherein the access point comprises a solar powered battery access point, an electric meter, a gas meter, a water meter, a street meter, a relay, or a proxy.

8. The method of claim 1, wherein the access point includes at least one of a power generation source or a mains power supply, and the BPD omits any power generation source or mains power supply.

9. The method of claim 1, wherein the BPD comprises a gas meter, a water meter, a sensor, an actuator, or internet of things (IoT) battery device.

10. The method of claim 1, wherein the first pacing requirement comprises 10 messages in 120 seconds and the second pacing requirement comprises 2 messages in 180 seconds.

11. A non-transitory computer-readable storage media storing computer-executable instructions that, when executed on one or more processors, cause the one or more processors to perform acts comprising:
receiving or generating, at a first device of devices in a network, a message to be sent to a second device of the devices in the network;
determining, by the first device, when to send the message to the second device based at least in part on:
a first pacing requirement which limits messages that can be sent by the first device to first hop neighbors of the first device to a first number of messages per first unit of time; and
a second pacing requirement which limits messages that can be sent to each branch in the network to a second number of messages per second unit of time; and
sending the message to the second device based at least in part on the first pacing requirement and the second pacing requirement.

12. The non-transitory computer-readable storage media of claim 11, causing the one or more processors to perform additional acts comprising:
determining, by the first device, when to send the message to the second device based at least in part on a rule that a single message is permitted to be in flight to the second device at a time; and
wherein sending the message to the second device is further based at least in part on the rule.

13. The non-transitory computer-readable storage media of claim 11, wherein determining when to send the message to the second device is further based at least in part on a queue of messages to be sent to the devices in the network.

14. The non-transitory computer-readable storage media of claim 13, wherein determining when to send the message to the second device is further based at least in part on a buffer servicing process, which determines when to send the message to the second device from among multiple messages in the queue of messages to be sent to the devices in the network.

15. The non-transitory computer-readable storage media of claim 14, wherein a medium access control (MAC) of the first device implements the buffer servicing process.

16. The non-transitory computer-readable storage media of claim 11, wherein the first device includes a mains power supply, and the second device omits any power generation source or mains power supply.

17. The non-transitory computer-readable storage media of claim 11, wherein determining when to send the message to the second device is further based at least in part on a schedule of listening windows of the devices in the network.

18. The non-transitory computer-readable storage media of claim 11, wherein the first pacing requirement comprises 10 messages in 120 seconds and the second pacing requirement comprises 2 messages in 180 seconds.

19. A method of pacing messages in a network of devices, the method comprising:
receiving or generating a message to be sent to a device of the devices in the network;
determining when to send the message to the device based at least in part on:
a rule that a single message is permitted to be in flight to any given neighbor device of the devices within the network at a time;
an aggregate pacing requirement which limits messages that can be sent to first hop neighbor devices of the devices within the network to a first number of messages per first unit of time; and
an individual pacing requirement which limits messages that can be sent to individual neighbor devices of the devices within the network to a second number of messages per second unit of time; and
sending the message to the device based at least in part on the rule, the aggregate pacing requirement, and the individual pacing requirement.

20. The method of claim 19, further comprising:
determining when to send the message to the device based at least in part on a rule that a single message is permitted to be in flight to any given neighbor device of the devices within the network at a time; and
wherein sending the message to the device is further based at least in part on the rule.

21. The method of claim 19, wherein determining when to send the message to the device is further based at least in part on a queue of messages to be sent to the devices in the network.

22. The method of claim 21, wherein determining when to send the message to the device is further based at least in part on a buffer servicing process, which determines when to send the message to the device from among multiple messages in the queue of messages to be sent to the devices in the network.

23. The method of claim 22, wherein a medium access control (MAC) of at least one of the devices in the network implements the buffer servicing process.

24. The method of claim 19, wherein determining when to send the message to the device is further based at least in part on a schedule of listening windows of the devices in the network.

25. The method of claim 19, wherein the aggregate pacing requirement comprises 10 messages in 120 seconds and the individual pacing requirement comprises 2 messages in 180 seconds.

26. A metering device comprising:
one or more processors; and
memory storing instructions that, when executed by the one or more processors, configure the metering device to perform operations comprising:
receiving or generating a message to be sent to a device of devices in a network;
determining when to send the message to the device based at least in part on:
an aggregate pacing requirement which limits messages that can be sent to first hop neighbor devices of the devices within the network to a first number of messages per first unit of time; and
an individual pacing requirement which limits messages that can be sent to individual neighbor devices of the devices within the network to a second number of messages per second unit of time; and
sending the message to the device based at least in part on the aggregate pacing requirement and the individual pacing requirement.

27. The metering device of claim 26, wherein the memory storing instructions that, when executed by the one or more processors, configure the metering device to perform additional operations comprising determining when to send the message to the device based at least in part on a rule that a single message is permitted to be in flight to any given neighbor device of the devices within the network at a time; and
wherein sending the message to the device is further based at least in part on the rule.

28. The metering device of claim 26, wherein determining when to send the message to the device is further based at least in part on a queue of messages to be sent to the devices in the network.

29. The metering device of claim 28, wherein determining when to send the message to the device is further based at least in part on a buffer servicing process, which determines when to send the message to the device from among multiple messages in the queue of messages to be sent to the devices in the network.

30. The metering device of claim 29, further comprising a medium access control (MAC), and wherein the MAC of the metering device implements the buffer servicing process.

31. The metering device of claim 26, wherein determining when to send the message to the device is further based at least in part on a schedule of listening windows of the devices in the network.
